(19) United States
(12) Patent Application Publication
(10) Pub. No.: US 2021/0283812 A1
(43) Pub. Date: Sep. 16, 2021

(54) BIAXIALLY ORIENTED POLYPROPYLENE MULTILAYER FILM AND METHODS THEREOF

(71) Applicant: Braskem S.A., Camaçari (BR)

(72) Inventor: Francisco Carlos Ruiz, São Paulo (BR)

(73) Assignee: Braskem S.A., Camaçari (BR)

(21) Appl. No.: 17/200,576

(22) Filed: Mar. 12, 2021

Related U.S. Application Data
(60) Provisional application No. 62/988,727, filed on Mar. 12, 2020.

(51) Int. Cl. B29C 48/00; B29C 48/18

(52) U.S. Cl. CPC B29C 48/022; B29K 2023/0625; B29C 48/0018; B29C 48/18

(57) ABSTRACT

A biaxially oriented multilayer film may include at least one sealing layer including at least a linear low density polyethylene (LLDPE); and at least one core layer including at least a polypropylene copolymer. A biaxially oriented polypropylene multilayer film, may include at least one sealing layer comprising at least a polyethylene blend and at least one core layer comprising at least a polypropylene copolymer, wherein the polyethylene blend comprises at least a linear low density polyethylene (LLDPE) and at least a high density polyethylene (HDPE).

### BACKGROUND

One of the myriad uses for polypropylene is for the induction of biaxially oriented polypropylene (BOPP) films. BOPP is used for both clear and opaque film production for various packaging applications, pressure sensitive tapes, labels, stationery, metallizing, consumer products as well as a wide variety of non-packaging uses. BOPP films are produced by drawing a cast sheet of polypropylene in two directions at a temperature below the melting temperature of the resin.

BOPP films are generally prepared by producing a cast film, and stretching the film biaxially under specific temperature (sufficient to orientate the polymer chains). The high temperature allows the relaxation of the molecules which would favor the stretch process and its orientation. This orientation provides an improvement of the film properties. In the sealing process at the packaging line of a BOPP film, elevated temperatures are applied; however, the temperatures cause a relaxation of the PP molecules and consequently a loss of the orientation, shrink and possibly a disruption.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a biaxially oriented multilayer film that includes at least one sealing layer including at least a linear low density polyethylene (LLDPE); and at least one core layer including at least a polypropylene copolymer.

In another aspect, embodiments disclosed herein relate to a biaxially oriented polypropylene multilayer film that includes at least one sealing layer comprising at least a polyethylene blend and at least one core layer comprising at least a polypropylene copolymer, wherein the polyethylene blend comprises at least a linear low density polyethylene (LLDPE) and at least a high density polyethylene (HDPE).

In another aspect, embodiments disclosed herein relate to a method of forming a biaxially oriented multilayer film that includes coextruding at least one layer of a linear low density polyethylene (LLDPE) and at least one layer of a polypropylene copolymer to form a multilayer film; and biaxially stretching the multilayer film to form a biaxially oriented multilayer film.

In yet another aspect, embodiments disclosed herein relate to a method of forming a biaxially oriented multilayer film that includes coextruding at least one layer of a polyethylene blend comprising linear low density polyethylene (LLDPE) and high density polyethylene (HDPE); and at least one layer of a polypropylene copolymer to form a multilayer film; and biaxially stretching the multilayer film to form a biaxially oriented multilayer film.

Other aspects and advantages of the claimed subject matter will be apparent from the following description and the appended claims.

### BRIEF DESCRIPTION OF DRAWINGS

FIG. 1 shows a tenter frame that may be used in accordance with one or more embodiments.

FIG. 2 shows a double bubble processing system that may be used in accordance with one or more embodiments.

FIG. 3 shows the results of a sealing test

### DETAILED DESCRIPTION

In one aspect, embodiments disclosed herein relate to biaxially oriented polypropylene (BOPP) multilayer films comprising at least a core layer and at least a sealing layer wherein the core layer comprises at least one polypropylene copolymer and the sealing layer comprises at least one linear low density polyethylene. In one or more embodiments, the multilayer film may include a structure of seal/core/seal.

The use of LLDPE as sealing layer makes unnecessary the need for a second lamination step commonly used for the application of a sealing material with higher thermal resistance or lower sealing temperature, since the LLDPE layer will already meet these requirements. Thus, by using a sealing layer comprising a material with a lower melt temperature, as compared to polypropylene, the sealing temperature used may be lower, such as in a range of 85 to 110° C., thereby maintaining the properties and flatness of the BOPP film. The sealing layer can be applied in a co-extrusion process with PP or laminated after the PP orientation process. Thus, the sealing layer material is selected to have a good compatibility with PP to avoid delamination, to have a stretch capability similar to PP (and to the BOPP), to have a low melt temperature, and be suitable to coextrusion.

The present inventors have found a combination of core and sealing layer materials that achieve such compatibility for a BOPP film and have low sealing temperature. Advantageously, the BOPP films of the present disclosure may possess higher puncture resistance properties, increased tear resistance, suitable Coefficient of Friction for each final application and more homogeneous surface treatment for printing and metallization.

In some embodiments, the polypropylene copolymer is a random copolymer, having at least one comonomer selected from ethylene and alpha olefins having 4 to 8 carbon atoms. In one or more embodiments, the comonomer content in the polypropylene copolymer may range from a lower limit of any of 0.2, 0.4, 0.6, or 0.8 wt %, and an upper limit of any of 1.2, 1.6, 2.0, 2.4, 2.8 or 3.2 wt %, based on the total weight of the polypropylene copolymer, where any lower limit can be used in combination with any upper limit.

In one or more embodiments, the polypropylene copolymer has a melt flow rate, measured according to ASTM D1238 (2.16 kg/230° C.), ranging from a lower limit of any of 1.0, 2.0, or 2.5 g/10 min to an upper limit of any of 4.0, 4.5, or 5.0 g/10 min, where any lower limit can be used in combination with any upper limit.

In one or more embodiments, the LLDPE may have a density, measured according to ASTM D792, ranging from 0.905 to 0.935 g/cm³.

In one or more embodiments, the LLDPE may have a melt flow rate, measured according to ASTM D1238 (2.16 kg/190° C.), ranging from a lower limit of any of 0.5, 0.6, 0.7, or 0.8 g/10 min to an upper limit of any of 4.5, 6.0, 10.0, 20.0, or 30.0 g/10 min, where any lower limit can be used in combination with any upper limit.

The LLDPE of the present disclosure is preferably produced using a metallocene catalyst. In some embodiments, LLDPE is a copolymer of ethylene and at least a comonomer selected from alpha-olefins with 3 to 16 carbon atoms, preferably butene or hexene.

In some embodiments, the sealing layer comprises a blend of LLDPE and high density polyethylene (HDPE). The use of HDPE in combination with LLDPE in the sealing layer may result in a less sticky sealing layer but still presenting good sealing performance. In some embodiments, the blend comprises HDPE in amount ranging from a lower limit of any of 2, 4, or 8 wt. % to an upper limit of any of 10, 15, or 20 wt %, where any lower limit can be used in combination with any upper limit, based on the total weight of the blend.

In one or more embodiments, the HDPE may have a melt flow rate, measured according to ASTM D1238 (2.16 kg/190° C.), ranging from a lower limit of any of 0.5, 0.6, 0.7, or 0.8 g/10 min to an upper limit of any of 4.5, 6.0, 10.0, 20.0, or 30.0 g/10 min, where any lower limit can be used in combination with any upper limit and density, measured according to ASTM D792, ranging from 0.945 to 0.955 g/cm3.

In particular embodiments, the multilayer film may include at least two layers, or at least three layers. In embodiments having at least three layers, the layers may be arranged such the polypropylene copolymer layer is an internal or core layer between two external or sealing layers of the LLDPE. In embodiments having at least five layers, the layers may be arranged such that the polypropylene copolymer layer may include one or more internal or core layers between two external or sealing layers of the LLDPE.

In one or more embodiments, the multilayer films may be formed to have a maximum thickness of about 3 mil, or more specifically, 1 mil or 0.5 mil in more particular embodiments. For example, in one or more embodiments, each sealing layer may have a thickness less than 0.1 mil, such as in a range of 0.02 to 0.06 mil in thickness.

The resulting biaxially oriented multilayer films may present a low Seal Initiation Temperature (SIT) measurements carried out on coextruded BOPP films, two heated flat teflonized jaws with dwell time of 1 sec and pressure of 2 bar. Further, the biaxially film may present a high ultimate seal strength in according to ASTM F88.

One or more embodiments also relate to a process for preparing such films that comprises the steps of: (I) providing a core layer composition, the polypropylene copolymer as described above, and a sealing layer composition, the LLDPE as described above; (II) coextruding the core and sealing layer compositions to produce a casting having adjacent core and sealing layers, optionally with an additional sealing layer to form a casting having the structure seal/core/seal; and (III) heating while stretching the casting in both longitudinal and transverse directions to produce an oriented film.

In a typical process for manufacturing films, raw material polymer is extruded or cast into a casting. The casting is then heated and stretched, such as on a tenter frame or bubble extrusion apparatus, and then quenched to form a film. Thereafter, the film is heated and stretched below its glass transition temperature in both longitudinal and transverse directions (and then quenched) to orient the polymer chains, which significantly improves the physical properties. Heating such a film will induce the film to shrink back to the prestretched configuration, the rate and amount of shrinkage being proportional to the temperature and duration of heating. However, the process for manufacturing may further comprise an optional step of maintaining the oriented film at a temperature less than the melting point of the polymer composition for an amount of time effective to reduce stresses induced during orientation and form a relaxed film. Restraining the film at an elevated temperature for a brief period of time will relax the stress induced during orientation, and thereby stabilize the film against shrinkage at elevated temperatures. In addition to relaxation, an optional step is to subject the film to a corona field, which can improve printing and sealing properties. A further optional step is analogous to the relaxation step just described, but is conducted at a temperature elevated from ambient temperature for a period of time effective to improve the packaging properties (e.g., creep, coefficient of friction) of the film. This annealing reduces stresses which cause low temperature shrinkage (i.e., creep). Commercial equipment for casting, bubble blowing, and corona treatment, annealing, and the like, are well known and available commercially. In addition to relaxation, an optional step is to subject the film to a corona field, which improve printing and metallizing processes.

In embodiments utilizing corona field, the relaxed film may be wound over a metal roll which serves as one electrode in a corona field. Film may be corona treated in a high energy field, typically 3 watt-min/ft², and at an elevated temperature generally in the range of 60° to 110° C. Corona treatment is typically used to improve the ability to print on the film with ink, for example, a tax stamp applied to cigarette packages by a state in which they are to be sold.

After corona treatment, the relaxed film is optionally annealed at only slightly elevated temperatures for a time sufficient to reduce stresses that would induce low temperature creep (e.g., creep at ambient and temperatures generally encountered storage conditions), although packages destined for prompt use may remain dimensionally stable without this annealing step. Generally, the film is heated to about 50° C. for about one day; in the following samples the film was held at 51° C. for 26 hours.

As mentioned above, BOPP film production in accordance with the present embodiments can be of any suitable technique including the tenter processing and double bubble film processing. In tenter frames, the polymer or polymers used to make the film are melted and then passed through an extruder to a slot die mechanism after which it is passed over a first roller, characterized as a chill roller, which tends to solidify the film. The film is then oriented by stressing it in a longitudinal direction, characterized as the machine direction, and in a transverse direction to arrive at a film which can be characterized in terms of orientation ratios, sometimes also referred to as stretch ratios, in both longitudinal and transverse directions.

The machine direction orientation may be accomplished through the use of two sequentially disposed rollers, the second or fast roller operating at a speed in relation to the slower roller corresponding to the desired orientation ratio. This may alternatively be accomplished through a series of rollers with increasing speeds, sometime with additional intermediate rollers for temperature control and other functions. After the film has been stressed in the machine direction, it is again cooled and then pre-heated and passed into a lateral stressing section, for example, a tenter frame mechanism, where it is again stressed, this time in the transverse direction. Orientation in the transverse direction may be followed by an annealing section. Subsequently, the film is then cooled and may be subjected to further treatment, such as a surface treatment (for example corona treatment or flame treatment).

Generally, a double-bubble process results in a biaxially oriented film that is simultaneously oriented in both the machine and transverse directions. This is in contrast to the tenter frame processing line where first machine direction orientation is followed by transverse (tenter direction) orientation.

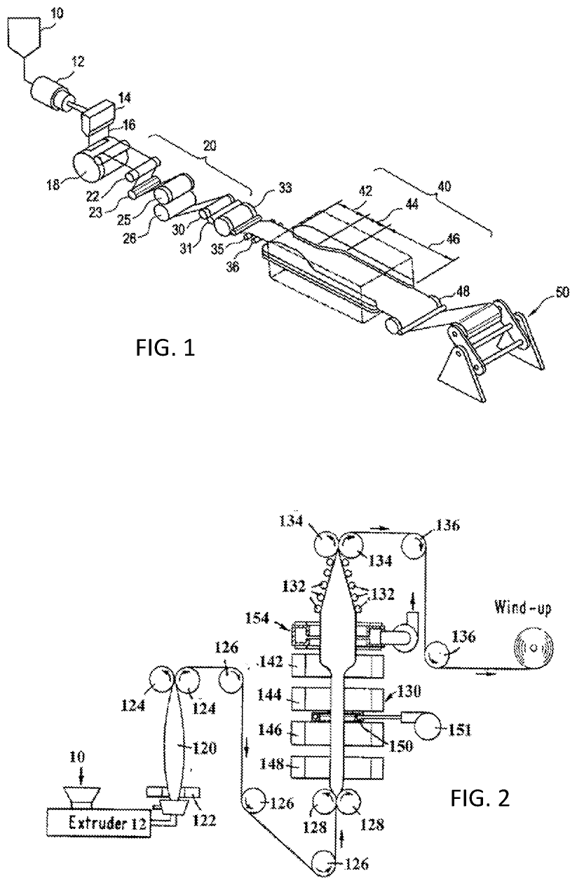

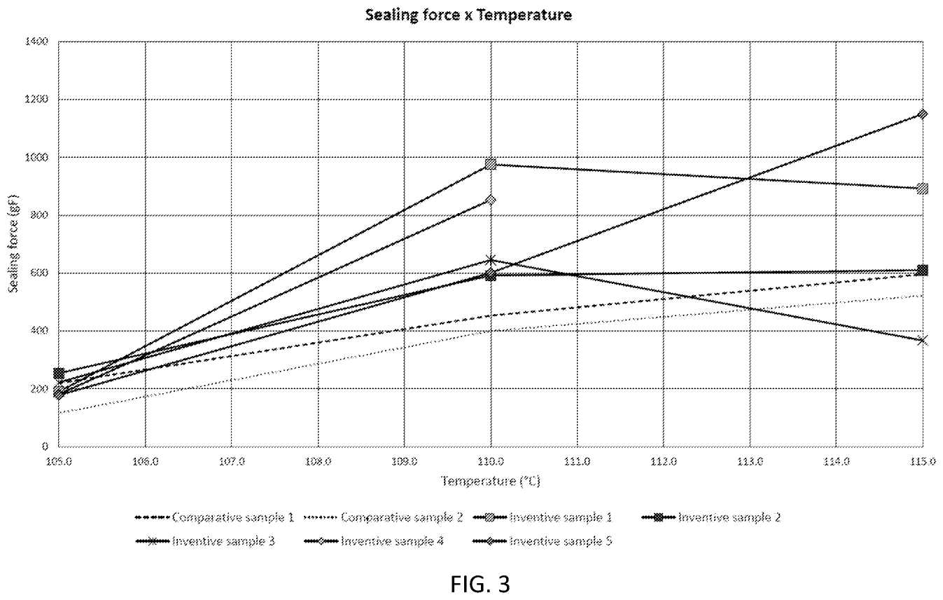

FIG. 1 illustrates a tenter frame that may be employed in producing biaxially-oriented polypropylene film in accordance with the present invention. In FIG. 1, a source of molten polymer is supplied from a heated hopper 10 to an extruder 12 and from there to a slot die 14 which produces a flat, relatively thick film 16 at its output. Film 16 is applied over a chill roller 18, and it is cooled to a suitable temperature. The film is drawn off the chill roller 18 to a stretching section 20 to which the machine direction orientation occurs by means of idler rollers 22 and 23 that lead to preheat rollers 25 and 26.

As the film is drawn off the chill roller 18 and passed over the idler rollers, it is cooled to a temperature of about 30-60° C. In stretching the film in the machine direction, it is heated by preheat rollers 25 and 26 to an incremental temperature increase of about 60-140° C. and is oriented by fast roller 31 operating at a suitable speed greater than that of the preheat rollers in order to orient the film in the machine direction.

As the oriented film is withdrawn from the fast roller 31, it is passed over a roller 33 at room temperature conditions. From here it is passed over rollers to a lateral stretching section 40 where the film is oriented by stretching in the transverse direction. The section 40 includes a preheat section 42 comprising a plurality of tandem heating rollers (not shown) where it is reheated to a temperature within the range of 130-180° C. From the preheat section 42 of the tenter frame, the film is passed to a stretching or draw section 44 where it is progressively stretched by means of tenter clips (not shown) which grasp the opposed sides of the film and progressively stretch it laterally until it reaches its maximum lateral dimension. The concluding portion of the lateral stretching phase includes an annealing section 46, such as an oven housing, where the film is heated at a temperature within the range of 130-170° C. for a suitable period in time. The annealing time helps control certain properties, and increased annealing is often specifically used to reduce shrinkage.

The biaxially oriented film is then withdrawn from the tenter frame and passed over a chill roller 48 where it is reduced to a temperature of less than about 50° C. and then applied to take-up spools on a takeup mechanism 50. Typically, the initial orientation in the machine direction is carried out at a somewhat lower temperature than the orientation in the lateral dimension. For example, the film may be stretched in the machine direction at a temperature of about 120° C. and stretched in the lateral dimension at a temperature of 160° C.

FIG. 2 illustrates the major components of such a double bubble processing line. The plastic feedstock 10 is fed into extruder 12. A primary bubble 120 forms by inflating the bubble as the melt exits die 122. Primary bubble 120 is cooled and collapsed as it passes through rollers 124. The resulting collapsed tube is then re-inflated to form the second bubble. The second bubble is heated to its draw temperature by means of external heaters 148, 146, 144, and 142. The amount of inflation determines the degree of orientation in the transverse direction. Machine direction orientation is imparted by having speed of the exit rollers 134 greater than the inlet rollers 128. Features to properly control the double-bubble process include special design of extruder die 122, air cooling areas 151 and 154 and guide rollers 132.

During the biaxially stretching, the stretching may have a total stretching ratio in the machine direction ranging from 2.25:1 to 4.5:1, and a total stretching ratio in the transverse direction ranging from 3.25:1 to 6:1. Further, the biaxially stretching may have a machine direction speed ranging from 250 to 750 mm/s.

### EXAMPLE

A multilayer film with 3 layers by coextrusion was produced having a core (or central layer) of polypropylene and two external layers (sealing layers) of several materials.

The polypropylene core layer is a polypropylene random copolymer with MFR 3.0 g/10 min according to ASTM D1238 (2.16 kg/230° C.) and amount of ethylene of 1.0 wt. %.

Table 1 below shows the composition of the external layers of each sample:

TABLE 1

| | | Density | MFR ** |
|---|---|---|---|
| | External layer | (g/cm³) | (g/10 min) |
| Inventive sample 1 | LLDPE | 0.916 | 0.9 |
| Inventive sample 2 | LLDPE | 0.920 | 25.0 |
| Inventive sample 3 | LLDPE | 0.917 | 1.0 |
| Inventive sample 4 | LLDPE | 0.918 | 3.5 |
| Inventive sample 5 | LLDPE | 0.918 | 0.9 |
| Comparative sample 1 | PP Terpolymer | 0.902 | 5.5 |
| | (propylene, | | |
| | ethylene, butene) | | |
| Comparative sample 2 | PP Terpolymer | 0.902 | 5.5 |
| | (propylene, | | |
| | ethylene, butene) | | |

** measured according to ASTM D 1238 230° C./2.16 kg for PP and 190° C./2.16 kg for PE

All LLDPE used in the inventive examples are obtained with metallocene catalysts and hexene comonomers.

The comparative samples materials are what is commonly used in the market for this application.

The conditions for the coextrusions include the extrusion of the polypropylene layer as set forth in Table 2, the extrusion of the external layers as set forth in Table 3, and the conditions for the feedblock as set forth in Table 4.

TABLE 2
Main extruder: production of the polypropylene layer:

| Temperature zones | |
|---|---|
| 1 | From 60 and 70° C. |
| 2 | From 150 and 190° C. |
| 3 | From 205 and 220° C. |
| 4 | From 205 and 220° C. |
| 5 | From 205 and 220° C. |
| 6 | From 205 and 220° C. |
| 7 | From 205 and 220° C. |
| Screw rotation | Between 140 and 160 rpm |
| Temperature of the melted polymer | Between 190 and 220° |
| Extruder pressure | Between 120 and 200 bar |

TABLE 3
Satellite extruders: production of the external layers

| Temperature zones | |
|---|---|
| 1 | From 60 and 70° C. |
| 2 | From 150 and 200° C. |
| 3 | From 170 and 220° C. |
| 4 | From 170 and 220° C. |
| 5 | From 170 and 220° C. |
| 6 | From 170 and 220° C. |
| 7 | From 170 and 220° C. |
| Screw rotation | Between 135 and 155 rpm |
| Temperature of the melted polymer | Between 190 and 215° C. |
| Extruder pressure | Between 90 and 230 bar |

TABLE 4
Feedblock-Five zones of temperature control:

| Temperature zones | |
|---|---|
| 1 | 200 e 210° C. |
| 2 | 200 e 210° C. |
| 3 | 200 e 210° C. |
| 4 | 200 e 220° C. |
| 5 | 200 e 220° C. |

The coextruded film was then biaxially stretched according to the orientation process conditions set forth in Table 5.

TABLE 5
Orientation process conditions

| | |
|---|---|
| Total stretching ratio (MD) | From 2.25 to 4.50 times |
| Total stretching ratio (TD) | From 3.25 to 6.00 times |
| Acceleration MD | From 5000 to 6000 mm/s² |
| Speed MD | From 250 to 1150 mm/s |

Samples of the resulting biaxially stretched multilayer films were subjected to a sealing test, the conditions for which are set forth in Table 6 below.

TABLE 6
Sealing Test Conditions

| | | |
|---|---|---|
| Film width to make the welding | 25.4 | mm |
| Sealing time | 2 | s |
| Traction speed | 300 | mm/min |

| | |
|---|---|
| Sealing bar dimensions | 10 mm × 150 mm |
| Sealing bar shape | Flat shape |

The results of the sealing test are shown in FIG. 1. As can be seen, at low temperatures (e.g. lower than 110° C.) the inventive samples presented higher sealing forces than the comparative examples.

Also, it was possible to obtain good sealing force even under very low temperatures. It was possible to obtain good sealability at a temperature of 105° C.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A biaxially oriented polypropylene multilayer film, comprising:
at least one sealing layer comprising at least a linear low density polyethylene (LLDPE) and
at least one core layer comprising at least a polypropylene copolymer.

2. The multilayer film of claim 1, wherein the LLDPE is a metallocene LLDPE.

3. The multilayer film of claim 1, wherein the LLDPE has a melt flow rate, measured according to ASTM D1238 (2.16 kg/190° C.), ranging from 0.5 to 30.0 g/10 min.

4. The multilayer film of claim 3, wherein the LLDPE has a melt flow rate, measured according to ASTM D1238 (2.16 kg/190° C.), ranging from 0.8 to 4.5 g/10 min.

5. The multilayer film of claim 1, wherein the LLDPE has a density, measured according to ASTM D792, ranging from 0.910 to 0.930 g/cm³.

6. The multilayer film of claim 1, wherein the polypropylene copolymer is a random copolymer.

7. The multilayer film of claim 1, wherein the polypropylene copolymer has at least one comonomer selected from ethylene and alpha olefins having 4 to 8 carbon atoms.

8. The multilayer film of claim 1, wherein the polypropylene copolymer has a comonomer content ranging from 0.2 to 3.2 wt % based on the total weight of the polypropylene copolymer.

9. The multilayer film of claim 1, wherein the polypropylene copolymer has a melt flow rate, measured according to ASTM D1238 (2.16 kg/230° C.), ranging from 1.0 to 5.0 g/10 min.

10. The multilayer film of claim 1, wherein the multilayer film comprises at least three layers.

11. The multilayer film of claim 1, wherein the multilayer film has an inner layer and two external layers, wherein the inner layer comprises the polypropylene copolymer, and the two external layers comprise at least one layer of the LLDPE.

12. The multilayer film of claim 1, wherein the at least one LLDPE layer has a thickness of less than 0.1 mil.

13. A biaxially oriented polypropylene multilayer film, comprising:
at least one sealing layer comprising at least a polyethylene blend and
at least one core layer comprising at least a polypropylene copolymer,
wherein the polyethylene blend comprises at least a linear low density polyethylene (LLDPE) and at least a high density polyethylene (HDPE).

14. The multilayer film of claim 13, wherein the HDPE is present in the polyethylene blend in an amount ranging from 2 to 20 wt. % based on the total weight of the blend.

15. The multilayer film of claim 13, wherein the HDPE has a melt flow rate, measured according to ASTM D1238 (2.16 kg/190° C.), ranging from 0.5 to 30.0 g/10 min.

16. The multilayer film of claim 15, wherein the HDPE has a melt flow rate, measured according to ASTM D1238 (2.16 kg/190° C.), ranging from 0.8 to 4.5 g/10 min.

17. The multilayer film of claim 13, wherein the HDPE has a density, measured according to ASTM D792, ranging from 0.945 to 0.955 g/cm3.

18. A method of forming a biaxially oriented multilayer film, comprising:
coextruding at least one layer of a linear low density polyethylene (LLDPE) and at least one layer of a polypropylene copolymer to form a multilayer film; and
biaxially stretching the multilayer film to form a biaxially oriented multilayer film.

19. The method of claim 18, wherein the biaxially stretching has a total stretching ratio in the machine direction ranging from 2.25:1 to 4.5:1.

20. The method of claim 18, wherein the biaxially stretching has a total stretching ratio in the transverse direction ranging from 3.25:1 to 6:1.

21. The method of claim 18, wherein the biaxially stretching has a machine direction speed ranging from 250 to 750 mm/s.

22. A method of forming a biaxially oriented multilayer film, comprising:
coextruding at least one layer of a polyethylene blend comprising linear low density polyethylene (LLDPE) and high density polyethylene (HDPE); and at least one layer of a polypropylene copolymer to form a multilayer film; and
biaxially stretching the multilayer film to form a biaxially oriented multilayer film.
